(19) United States
(12) Patent Application Publication
(10) Pub. No.: US 2024/0044658 A1
(43) Pub. Date: Feb. 8, 2024

(54) CONTROL APPARATUS AND DISPLAY APPARATUS

(71) Applicant: TOYOTA JIDOSHA KABUSHIKI KAISHA, Toyota-shi (JP)

(72) Inventors: Sui KURIHASHI, Sunto-gun (JP); Yuuji KOSAKA, Tokyo (JP)

(73) Assignee: TOYOTA JIDOSHA KABUSHIKI KAISHA, Toyota-shi (JP)

(21) Appl. No.: 18/219,465

(22) Filed: Jul. 7, 2023

(30) Foreign Application Priority Data
Aug. 3, 2022 (JP) 2022-124312

(51) Int. Cl. G01C 21/34; G01C 21/36; G08G 1/00

(52) U.S. Cl. CPC G01C 21/3469; G01C 21/3407; G01C 21/3697; G08G 1/22

(57) ABSTRACT

A control apparatus includes a control unit that executes display control of displaying information on a display apparatus. Further, while the vehicle is running toward a destination set in navigation information, the control unit generates a time image indicating whether an estimated arrival time is shortened or prolonged with respect to an original scheduled arrival time as information regarding a scheduled time at which the vehicle arrives at the destination, and the control unit generates an effect image indicating an energy consumption reduction effect, and the control unit displays the generated time image and the effect image in real time on the display apparatus.

### CROSS-REFERENCE TO RELATED APPLICATION(S)

The present application claims priority to and incorporates by reference the entire contents of Japanese Patent Application No. 2022-124312 filed in Japan on Aug. 3, 2022.

### BACKGROUND

The present disclosure relates to a control apparatus and a display apparatus.

Japanese Laid-open Patent Publication No. 2019-101677 discloses a platooning system that forms a platoon in which a vehicle superior in straight line stability is arranged at the forefront in consideration of straight line stability of each vehicle, in a case where a plurality of automatically-operated vehicles desires to perform platooning.

### SUMMARY

There is a need for providing a control apparatus and a display apparatus that can achieve both of an attainment of a driving schedule and an improvement in energy consumption reduction effect.

According to an embodiment, a control apparatus includes: a control unit to execute display control of displaying information regarding a running vehicle on a display apparatus. Further, while the vehicle is running toward a destination set in navigation information, the control unit generates a time image indicating whether an estimated arrival time estimated based on a vehicle speed of the vehicle and the navigation information is shortened or prolonged with respect to an original scheduled arrival time defined by the navigation information at a running start time point, as information regarding a scheduled time at which the vehicle arrives at the destination, the control unit generates an effect image indicating an energy consumption reduction effect to be obtained in the vehicle by a current running state of the vehicle, and in the control unit displays the generated time image and the effect image in real time on the display apparatus.

According to an embodiment, there is a display apparatus displaying information regarding a running vehicle. Further, while the vehicle is running toward a destination set in navigation information, the display apparatus displays, in real time, a time image indicating information regarding a scheduled arrival time at the destination and an effect image indicating an energy consumption reduction effect, the time image is an image indicating whether an estimated arrival time estimated based on a vehicle speed of the vehicle and the navigation information is shortened or prolonged with respect to an original scheduled arrival time defined by the navigation information at a running start time point, and the effect image is an image indicating an energy consumption reduction effect to be obtained in the vehicle by a current running state of the vehicle.

### BRIEF DESCRIPTION OF THE DRAWINGS

FIG. 1 is a block diagram schematically illustrating a vehicle according to a first embodiment;

FIG. 2 is a flowchart illustrating a display control flow;

FIG. 3 is a diagram illustrating a first display example in which a time image and an effect image are displayed in real time;

FIG. 4 is a diagram illustrating a second display example in which a time image and an effect image are displayed in real time;

FIG. 5 is a diagram illustrating a first modified example of image display;

FIG. 6 is a diagram illustrating a second modified example of image display;

FIG. 7 is a diagram illustrating a control apparatus according to a second embodiment;

FIG. 8 is a diagram illustrating a control apparatus according to a third embodiment; and

FIG. 9 is a diagram illustrating a running state according to the third embodiment.

### DETAILED DESCRIPTION

In the related art, for example, like an effect to be obtained by executing the platooning described in Japanese Laid-open Patent Publication No. 2019-101677, there has been a demand for a technique of running without a delay from a driving schedule while receiving an energy consumption reduction effect to be obtained by a vehicle running in an efficient running state.

Hereinafter, a control apparatus and a display apparatus according to an embodiment of the present disclosure will be specifically described with reference to the drawings. Note that the present disclosure is not limited to the embodiments to be described below.

### First Embodiment

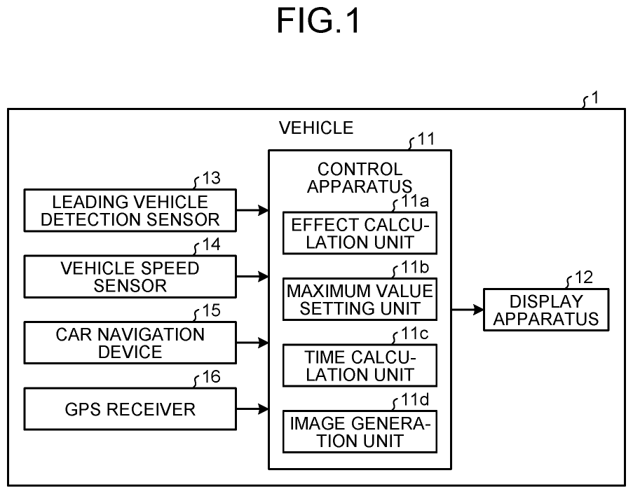

FIG. 1 is a block diagram schematically illustrating a vehicle according to the first embodiment. In the first embodiment, a vehicle 1 is configured to be able to provide a driver with information regarding the running vehicle 1, when executing platooning. The vehicle 1 is configured to be able to visualize information regarding the vehicle 1. For example, a system (automatic tracking system) that causes the vehicle 1 to run while tracking a leading vehicle running in front of the own vehicle, such as radar cruise control, automatic cruise control, or adaptive cruise control, is mounted on the vehicle 1.

The vehicle 1 includes a control apparatus 11 and a display apparatus 12.

The control apparatus 11 includes an electronic control device that controls the vehicle 1. The electronic control device includes a microcontroller including a central processing unit (CPU), a random access memory (RAM), a read-only memory (ROM), and an input-output interface. The control apparatus 11 performs signal processing in accordance with a program prestored in the ROM. In addition, signals from various sensor mounted on the vehicle 1 are input to the control apparatus 11. The vehicle 1 includes a leading vehicle detection sensor 13 and a vehicle speed sensor 14 as in-vehicle sensors.

The leading vehicle detection sensor 13 is a sensor that detects a leading vehicle being a vehicle running in front of the vehicle 1. The leading vehicle detection sensor 13 includes a front facing camera, a millimeterwave radar, and the like, for example. In the first embodiment, the leading vehicle detection sensor 13 includes a front facing camera and a millimeterwave radar. Thus, the leading vehicle detection sensor 13 outputs leading vehicle information including an image captured by the front facing camera, and a measurement result of the millimeterwave radar, to the control apparatus 11.

The vehicle speed sensor 14 detects a vehicle speed of the vehicle 1 based on a pulse signal corresponding to the number of revolutions of a wheel axis.

Then, signals output from the leading vehicle detection sensor 13 and the vehicle speed sensor 14 are input to the control apparatus 11. Using the leading vehicle information input from the leading vehicle detection sensor 13, the control apparatus 11 detects a vehicle (leading vehicle) to be tracked by the own vehicle. Because the leading vehicle information includes an image of an own vehicle front side and a measurement result obtained by the radar, in the control apparatus 11, a leading vehicle can be detected based on the image of the own vehicle front side and a measurement result of the millimeterwave radar.

In addition, the control apparatus 11 executes display control of displaying information regarding the vehicle 1 executing platooning, based on signals input from various sensors. The control apparatus 11 includes a control unit that executes display control. Then, when executing the display control, the control apparatus 11 generates an effect image B corresponding to an energy consumption reduction effect to be obtained by platooning, and causes the effect image B to be displayed on the display apparatus 12.

More specifically, the control apparatus 11 includes an effect calculation unit 11a, a maximum value setting unit 11b, a time calculation unit 11c, and an image generation unit 11d.

In a case where platooning is executed, the effect calculation unit 11a calculates an energy consumption reduction effect to be obtained in the vehicle 1. The effect calculation unit 11a calculates an energy consumption reduction effect to be obtained when the vehicle 1 runs while tracking a leading vehicle detected by the leading vehicle detection sensor 13 (platooning).

The effect calculation unit 11a calculates, as an energy consumption reduction effect, an air resistance reduction effect to be obtained by platooning. An air resistance to be received by the vehicle 1 during running is obtained by multiplying a frontal projected area of the vehicle 1 by an air resistance coefficient and a pressure. In addition, an air resistance reduction effect to be obtained by platooning can be calculated based on a physical size of a leading vehicle, a distance (inter-vehicular distance) between the vehicle 1 and the leading vehicle, and a vehicle speed. In this case, the physical size of the leading vehicle and the inter-vehicular distance from the leading vehicle can be calculated based on leading vehicle information acquired by the leading vehicle detection sensor 13.

For example, by analyzing the own vehicle front side image acquired by the front facing camera included in the leading vehicle detection sensor 13, the effect calculation unit 11a calculates the physical size of the leading vehicle, and also calculates the inter-vehicular distance between the vehicle 1 and the leading vehicle. Alternatively, the effect calculation unit 11a calculates the inter-vehicular distance between the vehicle 1 and the leading vehicle based on a radar measurement result acquired by the millimeterwave radar included in the leading vehicle detection sensor 13. The vehicle speed can be detected by the vehicle speed sensor 14. Then, the effect calculation unit 11a calculates an air resistance reduction effect based on the physical size of the leading vehicle, the inter-vehicular distance, and the vehicle speed. As an example, in a case where the inter-vehicular distance from the leading vehicle is short, an air resistance reduction effect becomes larger, and in a case where the inter-vehicular distance from the leading vehicle is long, an air resistance reduction effect becomes smaller.

The maximum value setting unit 11b sets a temporary maximum value indicating a state in which an energy consumption reduction effect is sufficiently obtained. The temporary maximum value can be set like “20%”, for example. Because an energy consumption reduction effect caused by platooning cannot be obtained in a case where the vehicle 1 is not executing platooning, such an effect can be represented by a percentage like “0%”. On the other hand, because an energy consumption reduction effect caused by platooning can be obtained in a case where the vehicle 1 is executing platooning, the obtained reduction effect can be represented as a positive value like “15%”.

Then, the maximum value setting unit 11b sets a temporary maximum value to a value smaller than “100%”. This is to prevent a driver from requiring an energy consumption reduction effect too much. In a case where “100%” is set as the maximum value and an energy consumption reduction effect is displayed on the display apparatus 12, even if the energy consumption reduction effect is “20%” indicating a state in which an energy consumption reduction effect is sufficiently obtained, a driver feels that as many as “remaining 80%” is still left to be obtained until the maximum value of “100%” is obtained. In this state, the driver is expected to further require a fuel consumption improvement effect. To prevent this, the temporary maximum value is set in the control apparatus 11. That is, the control apparatus 11 executes various types of control in such a manner that both of the attainment of a driving schedule and a fuel consumption improvement effect can be achieved.

The time calculation unit 11c calculates a scheduled arrival time at the destination. The control apparatus 11 can acquire navigation information from a car navigation device 15. For example, in a case where a driver of the vehicle 1 sets a destination by operating the car navigation device 15, information regarding the destination set on the car navigation device 15 is input to the control apparatus 11 as navigation information. In addition, a positioning signal received by a global positioning system (GPS) receiver 16 is input to the control apparatus 11. The control apparatus 11 can acquire position information of the vehicle 1 from the GPS receiver 16. Then, while the vehicle 1 is running toward the destination, the time calculation unit 11c estimates (calculates) a scheduled arrival time at the destination based on the current running state, and calculates a difference between the estimated scheduled arrival time and an original scheduled arrival time defined at a running start time point. That is, while the vehicle 1 is executing platooning, the control apparatus 11 estimates a scheduled arrival time at the destination using information indicating the current running state, and navigation information.

The original scheduled arrival time may be a time set by the driver of the vehicle 1 by operating the car navigation device 15, or may be a time (calculated value) calculated by the time calculation unit 11c. In a case where the original scheduled arrival time is a calculated value, the time calculation unit 11c can calculate a scheduled arrival time based on position information of the vehicle 1 at a running start time point, information regarding the destination that is indicated by navigation information, and information regarding a scheduled running route. The calculated scheduled arrival time is used for the control of the control apparatus 11 as a supposed arrival time (original scheduled arrival time) on which a driving schedule is based.

A scheduled arrival time to be estimated during running is calculated based on position information of the vehicle 1, vehicle speed information of the vehicle 1, information regarding the destination, and information regarding the scheduled running route. As the vehicle speed information, any of a current vehicle speed, a most recent vehicle speed, and an average vehicle speed in several minutes is used. While the vehicle 1 is executing platooning the time calculation unit 11c calculates a scheduled arrival time that is based on current running information. The calculated scheduled arrival time is used for the control of the control apparatus 11 as an estimated arrival time estimated when a current running state is continued for a driving schedule.

Then, while the vehicle 1 is executing platooning, the control apparatus 11 can determine whether the scheduled arrival time (estimated arrival time) estimated based on the current running state becomes earlier or later as compared with the original scheduled arrival time (supposed arrival time) supposed at the running start time point. In other words, by calculating a difference time of the estimated arrival time from the supposed arrival time during platooning, the control apparatus 11 can determine that a required time has been “shortened” or “prolonged” from an originally-supposed required time.

The image generation unit 11d generates an image indicating information regarding the vehicle 1. The image generation unit 11d generates the image in accordance with calculation results obtained by the effect calculation unit 11a and the time calculation unit 11c, and the temporary maximum value set by the maximum value setting unit 11b. Then, image data generated by the image generation unit 11d is output to the display apparatus 12.

The display apparatus 12 displays information regarding the vehicle 1 executing platooning. The display apparatus 12 is a display that is arranged inside a vehicle interior of the vehicle 1, and displays an image at a position visible to the driver of the vehicle 1. For example, the display apparatus 12 includes a multi-information display or a headup display. In addition, the display apparatus 12 is controlled by the control apparatus 11, and displays an image in accordance with a signal input from the control apparatus 11.

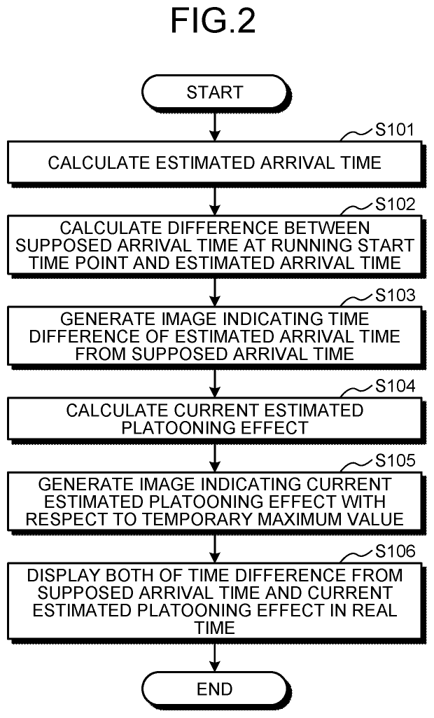

FIG. 2 is a flowchart illustrating a display control flow. Note that the control illustrated in FIG. 2 is repeatedly executed by the control apparatus 11 while the vehicle 1 is executing platooning.

While the vehicle 1 is executing platooning, the control apparatus 11 calculates a scheduled arrival time at the destination that is to be obtained when the current running state is continued (Step S101). In Step S101, an estimated arrival time is calculated (estimated). The processing in Step S101 is executed by the time calculation unit 11c.

The control apparatus 11 calculates a difference between a supposed arrival time at a running start time point, and the estimated arrival time corresponding to the current running state (Step S102). In Step S102, a difference time of the estimated arrival time from the supposed arrival time is calculated. The processing in Step S102 is executed by the time calculation unit 11c.

Then, the control apparatus 11 generates an image indicating the difference time of the estimated arrival time from the supposed arrival time (Step S103). In Step S103, based on the calculation result obtained in Step S102, a time image A indicating whether a schedule arrival time at the destination is shortened or prolonged with respect to a reference value is generated.

For example, in a case where the estimated arrival time becomes earlier than the supposed arrival time, in Step S103, the time image A indicating “shortened” is generated. In addition, in a case where the estimated arrival time becomes later than the supposed arrival time, in Step S103, the time image A indicating “prolonged” is generated. The processing in Step S103 is executed by the image generation unit 11d.

In addition, the control apparatus 11 calculates a current platooning effect (Step S104). In Step S104, when the vehicle 1 is executing platooning, an energy consumption reduction effect to be obtained in the vehicle 1 by platooning is calculated. The processing in Step S104 is executed by the effect calculation unit 11a.

The control apparatus 11 generates an image indicating a current platooning effect with respect to a temporary maximum value (Step S105). In Step S105, the effect image B indicating a current energy consumption reduction effect with respect to a preset temporary maximum value is generated. The effect image B is generated as an image in which information regarding an energy consumption reduction effect is indicated by a meter. In addition, the temporary maximum value is a value defined by the maximum value setting unit 11b, and a value indicating a state in which an energy consumption reduction effect can be sufficiently obtained.

Then, the control apparatus 11 displays both of the difference time from the supposed arrival time and the current estimated platooning effect in real time (Step S106). In Step S106, the image indicating the difference time of the estimated arrival time from the supposed arrival time, and the image indicating the current energy consumption reduction effect with respect to the temporary maximum value are displayed in real time on the display apparatus 12. At the time, image data is output from the control apparatus 11 to the display apparatus 12. On the display apparatus 12, the time image A indicating “shortened” or “prolonged” is displayed with a meter, and the effect image B indicating a range between the temporary maximum value and 0% is displayed with a meter. In addition, by the images being displayed in real time, a meter indicating a difference time and a meter indicating a reduction effect vary in real time. If the processing in Step S106 is executed, this control routine ends.

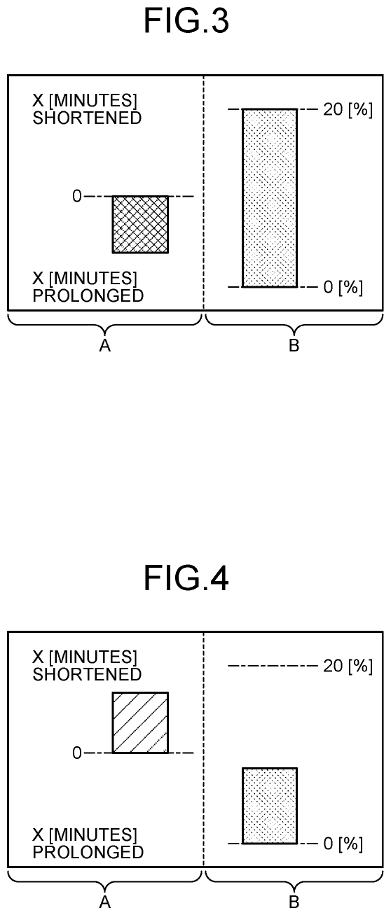

The vehicle 1 having such a configuration can acquire information regarding a relative position between the vehicle 1 and a leading vehicle, using an autonomous sensor such as a millimeterwave radar. Then, as illustrated in FIGS. 3 and 4, for example, the time image A regarding an arrival time is displayed on the display apparatus 12 next to the effect image B indicating an effect to be obtained by platooning.

As illustrated in FIG. 3, in a case where an estimated arrival time becomes later than a supposed arrival time, and an energy consumption reduction effect to be obtained by platooning is large, a meter extending toward the “prolonged” side from a reference value is displayed as the time image A, and a meter that has reached a temporary maximum value of “20%” is displayed as the effect image B. In addition, in the time image A, time shortening and prolongation are displayed using “X” minutes as an upper limit value. The X minutes indicate a value set by the control apparatus 11. For example, “X minutes” can be set to an arbitrary value such as “20 minutes” or “30 minutes” by the car navigation device 15. In a case where “X” is set to “20”, an image indicating “20 [minutes] shortened” or “20 [minutes] prolonged” is displayed on the display apparatus 12.

As illustrated in FIG. 4, in a case where an estimated arrival time becomes earlier than a supposed arrival time, and an energy consumption reduction effect to be obtained by platooning is small, a meter extending toward the “shortened” side from a reference value is displayed as the time image A, and a meter indicating a value smaller than the temporary maximum value is displayed as the effect image B.

In this manner, by displaying together an image indicating time shortening or prolongation that is based on a supposed arrival time, and an image indicating an energy consumption reduction effect to be obtained by platooning, a driver who views the displayed images can determine how driving is to be performed to keep a balance between time and fuel consumption.

As described above, it is possible to present a current temporal difference from a driving schedule to a driver by image display, and also display an image indicating a difference time with respect to a driving schedule, together with an image indicating whether the current driving state is an ecological driving state. Then, the driver can obtain information for making a decision to change a driving state. With this configuration, it is possible to achieve both of the attainment of a driving schedule and a fuel consumption improvement effect.

For example, when a driver moves on the vehicle 1 to participate in an event held at a remote location, in a case where the driver departs with a driving schedule created in such a manner as to make it by eleven in the morning, by departing with plenty of time to spare and properly utilizing a platooning mode, it is possible to run on an express highway in a state in which a reduction effect is high. That is, it is possible to find an effective leading vehicle on the express highway in the platooning mode, and perform platooning of tracking the leading vehicle. Nevertheless, if a vehicle speed becomes lower due to platooning, although a large energy consumption reduction effect obtained by platooning can be received, an arrival time might be delayed from an originally-scheduled arrival time. In view of the foregoing, using the time image A and the effect image B displayed on the display apparatus 12, as information for making a decision, the driver can change a running state to a running state aimed at time shortening, by increasing a speed even by reducing an energy consumption reduction effect to be obtained by platooning. Then, the driver has arrived at the destination in such a manner as to make it by the scheduled time, eleven in the morning. In this manner, using image information displayed on the display apparatus 12 during platooning, as information for making a decision effectively works.

Note that a power source for running of the vehicle 1 is not specifically limited. For example, in a case where the vehicle 1 is a battery electric vehicle on which a motor is mounted as a power source, by supplying the motor with electric power stored in a battery, the motor is driven and the vehicle 1 can run. Because the vehicle 1 runs based on power obtained by consuming electric power, if a running state with good energy efficiency is caused, power consumption improves, and a cruising distance can be extended. In this case, the effect calculation unit 11a calculates an effect (power consumption improvement effect) of reducing consumed power in platooning. In addition, in a case where the vehicle 1 is a vehicle on which an engine is mounted, for example, the effect calculation unit 11a calculates an effect (fuel consumption improvement effect) of reducing fuel to be consumed in platooning.

In addition, the display apparatus 12 may be the car navigation device 15. In short, the display apparatus 12 includes a human machine interface (HMI). That is, the display apparatus 12 may be an apparatus mounted on the vehicle 1, or may be a mobile terminal such as a smartphone, for example, that is brought into the vehicle 1 by a driver. In a case where the display apparatus 12 is a smartphone, the control apparatus 11 is configured to be able to communicate with the smartphone, and image data transmitted from the control apparatus 11 is displayed on a display of the smartphone.

In addition, the time image A and the effect image B that are displayed in real time on the display apparatus 12 are not limited to the display examples illustrated in FIGS. 3 and 4. For example, a minimum value and a maximum value in the effect image B are not limited to the combination of “0%” and “20%”, and can be set to arbitrary values. In short, upper and lower limit values of the meter in the time image A, and upper and lower limit values in the effect image B are not specifically limited.

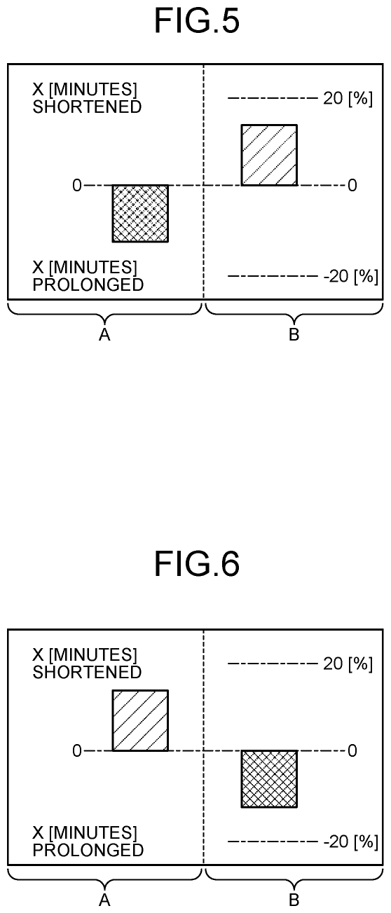

As an example, it is possible to display images on the display apparatus 12 by a display method as illustrated in FIGS. 5 and 6. In this display method, an effect image B indicating a temporary maximum value of “20%” or a temporary minimum value of “−20%” is displayed.

As illustrated in FIG. 5, in a case where an estimated arrival time becomes later than a supposed arrival time, and an energy consumption reduction effect to be obtained by platooning is large, a meter extending toward the “prolonged” side from a reference value is displayed as the time image A, and a meter extending toward a “positive value” side is displayed as the effect image B. The positive value indicates a state in which energy consumption is reduced.

As illustrated in FIG. 6, in a case where an estimated arrival time becomes earlier than a supposed arrival time, and an energy consumption reduction effect to be obtained by platooning is small, a meter extending toward the “shortened” side from a reference value is displayed as the time image A, and a meter extending toward a “negative value” side is displayed as the effect image B. The negative value indicates a state in which energy consumption is increased.

In addition, when the vehicle 1 is executing platooning with a time designated by an occupant of the vehicle 1 being set as a targeted arrival time, the control apparatus 11 can display, on the display apparatus 12, information indicating whether the vehicle 1 can arrive at a destination by the targeted arrival time.

For example, in a case where a driver of the vehicle 1 has designated the targeted arrival time by operating an HMI such as the car navigation device 15, the control apparatus 11 sets the designated time as a targeted arrival time based on the input information. The time calculation unit 11c calculates an estimated arrival time that considers a delay in an arrival time at the destination that is to be caused by platooning. Then, while the vehicle 1 is executing platooning, the control apparatus 11 determines goal achievability by comparing a scheduled arrival time calculated by the time calculation unit 11c, and a preset targeted arrival time In a case where the estimated arrival time is earlier than the targeted arrival time, a determination result indicating that a goal is achievable is obtained, and in a case where the estimated arrival time is later than the targeted arrival time, a determination result indicating that a goal is unachievable is obtained. Furthermore, the control apparatus 11 generates an image (achievability image) indicating a goal achievability result, in accordance with the determination result, and causes the image to be displayed on the display apparatus 12. In other words, the control apparatus 11 generates, during platooning, an achievability image indicating a goal achievability result obtained by comparing the targeted arrival time and the estimated arrival time that considers a delay in an arrival time at the destination that is to be caused by platooning. Then, the control apparatus 11 causes the generated achievability image to be displayed in real time on the display apparatus 12. In this case, the control apparatus 11 can display the achievability image on the display apparatus 12 in place of the time image A. When the vehicle 1 is executing platooning, the display apparatus 12 can display the achievability image in real time in place of the time image A. With this configuration, the driver of the vehicle 1 can visually recognize whether or not the vehicle 1 is to make it by the targeted arrival time designated by the driver. By the image indicating a goal achievability result, being displayed on the display apparatus 12 in this manner, it becomes unnecessary for the driver to perform an operation for confirming whether or not the vehicle 1 is to make it by the targeted arrival time, by operating an HMI during platooning, and burden on the driver can be reduced.

Note that the control apparatus 11 is only required to be configured to cause at least one of the time image A and the achievability image to be displayed on the display apparatus 12, and can also cause both the time image A and the achievability image to be displayed on the display apparatus 12. The same applies to the display apparatus 12.

### Second Embodiment

In the second embodiment, unlike the first embodiment, a vehicle 1 is configured to be able to prevent a delay from a driving schedule while receiving an energy consumption reduction effect to be obtained by vehicle speed control, while assuming a case where the vehicle 1 is running in a vehicle speed limited state. Note that, in the description of the second embodiment, the description of components similar to those in the first embodiment will be omitted, and their reference numerals will be cited.

In the second embodiment, when a control apparatus 11 executes display control, an input signal from a leading vehicle detection sensor 13 becomes unnecessary. In addition, the control apparatus 11 can execute vehicle speed limitation control of limiting a vehicle speed of the vehicle 1 to a predetermined upper limit value. Then, while the control apparatus 11 is executing the vehicle speed limitation control, the control apparatus 11 calculates an energy consumption reduction effect corresponding to the current vehicle speed, based on an input signal from a vehicle speed sensor 14.

While the vehicle 1 is running in a state in which a vehicle speed is limited to the predetermined upper limit value (vehicle speed limited state), the effect calculation unit 11a calculates an energy consumption reduction effect corresponding to the vehicle speed, based on a signal input from the vehicle speed sensor 14. When the effect calculation unit 11a calculates an energy consumption reduction effect to be obtained by vehicle speed limitation, the effect calculation unit 11a calculates the energy consumption reduction effect in such a manner that the energy consumption reduction effect becomes smaller as the vehicle speed becomes closer to the upper limit value.

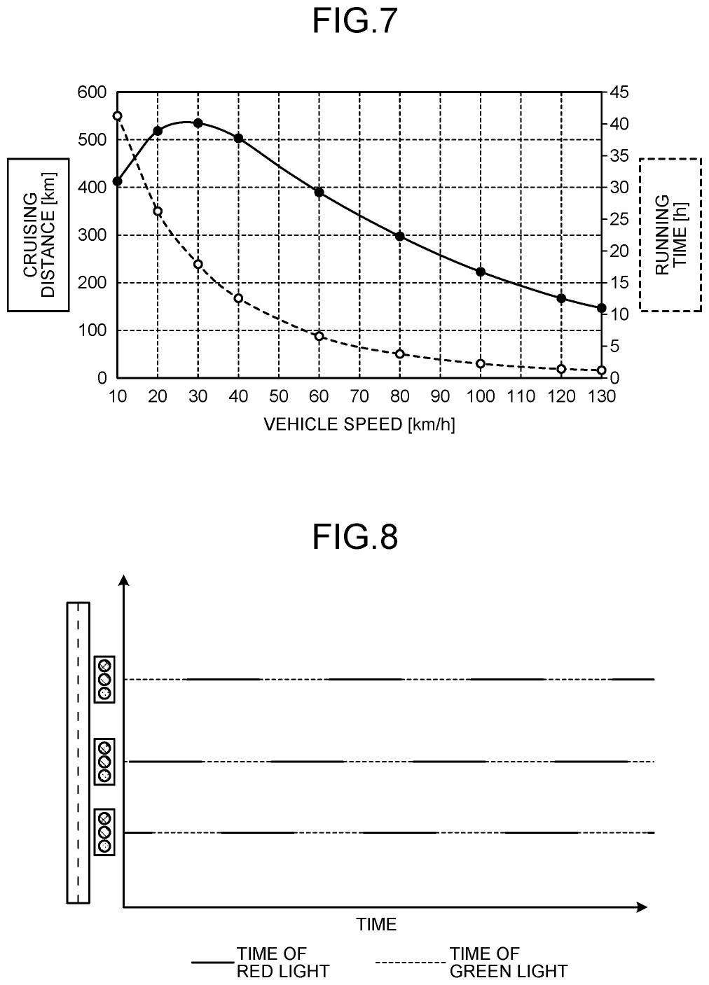

As illustrated in FIG. 7, relationship between vehicle speed and cruising distance is such relationship that a cruising distance becomes shorter as a vehicle speed becomes larger. Thus, using a map illustrated in FIG. 7, and the current vehicle speed of the vehicle 1, the control apparatus 11 can define a cruising distance for each vehicle speed.

In addition, FIG. 7 exemplifies a case where the vehicle 1 is a battery electric vehicle in which a motor serves as power source, and a battery capacity is 30 kWh. In this case, an energy consumption reduction effect becomes a power consumption improvement effect. In other words, because electric power stored in a battery is limited, a running state in which a cruising distance can be extended and a running time can be made longer becomes a running state with a high power consumption improvement effect.

In the example illustrated in FIG. 7, the relationship between cruising distance and vehicle speed is such relationship that a cruising distance extends as a vehicle speed increases up to the speed near 30 km/h, and after the peak speed near 30 km/h, the cruising distance becomes shorter as the vehicle speed increases. From the viewpoint of cruising distance, in a speed range in which the vehicle speed is larger than 30 km/h, a power consumption improvement effect becomes lower as a vehicle speed increases.

As illustrated in FIG. 7, the relationship between running time and vehicle speed is such relationship that a running time becomes shorter as a vehicle speed increases. From the viewpoint of running time, in the entire speed range, a power consumption improvement effect becomes lower as a vehicle speed increases.

In this manner, while the vehicle 1 is running in the vehicle speed limited state, the control apparatus 11 executes display control of calculating an energy consumption reduction effect based on a vehicle speed, generating an effect image B corresponding to the calculation result, and displaying the effect image B on a display apparatus 12. Also in the second embodiment, a time image A and the effect image B can be adjacently displayed by the display method illustrated in FIGS. 3 to 6.

As described above, according to the second embodiment, it becomes possible to attain a driving schedule while receiving an energy consumption reduction effect to be obtained by vehicle speed limitation.

Note that, in the second embodiment, a case where the vehicle 1 is a battery electric vehicle has been described, but the vehicle 1 is not limited to this. The vehicle 1 may be a vehicle in which an engine serves as a power source. In other words, an energy consumption reduction effect is only required to be at least either one of a fuel consumption improvement effect and a power consumption improvement effect.

### Third Embodiment

In the third embodiment, unlike the first embodiment, a vehicle 1 is configured to be able to run in a state in which the vehicle 1 can always pass through a traffic light in a state in which a lighting color of the traffic light is green, using information regarding a traffic light provided on a scheduled running route. Note that, in the description of the third embodiment, the description of components similar to those in the first embodiment will be omitted, and their reference numerals will be cited.

In the third embodiment, when a control apparatus 11 executes display control, an input signal from a leading vehicle detection sensor 13 becomes unnecessary. In addition, the control apparatus 11 is configured to be able to perform road-to-vehicle communication, and can perform wireless communication with a device on a road side. The vehicle 1 can acquire information regarding a lighting color of a traffic light, by the road-to-vehicle communication. Then, the control apparatus 11 can perform control in such a manner as to bring the vehicle 1 into a running state in which the vehicle 1 can always pass through a traffic light in a state in which a lighting color of the traffic light is green. The control apparatus 11 can perform so-called green wave (or blue wave) driving assist control.

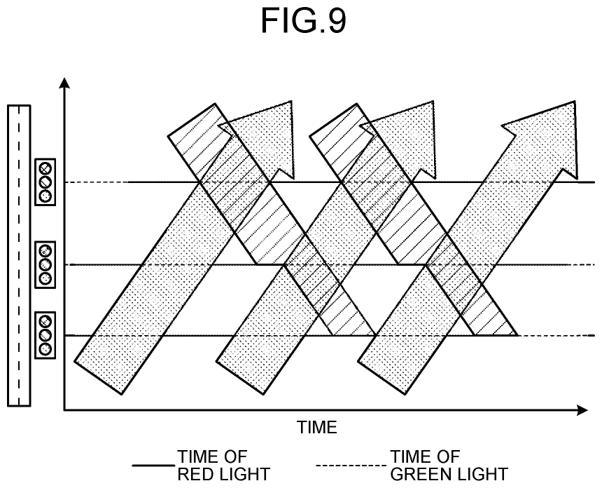

As illustrated in FIGS. 8 and 9, when the vehicle 1 passes through a plurality of traffic lights, the vehicle 1 can pass through each traffic light at a timing at which a corresponding traffic light indicates a green light. Based on information acquired by road-to-vehicle communication, the control apparatus 11 can assist the running of the vehicle 1 in such a manner that each traffic light enters a green light state at a timing at which the vehicle 1 passes through a corresponding traffic light, as indicated by arrows illustrated in FIG. 9. Then, while executing green wave driving assist control, the control apparatus 11 calculates an energy consumption reduction effect to be obtained by being in the control state.

While the vehicle 1 is running in a control state in which the vehicle 1 is assisted to drive in such a manner that the vehicle 1 can pass through a plurality of traffic lights at timings at which lighting colors of the traffic lights are green (state in which green wave driving assist control is executed), the effect calculation unit 11a calculates an energy consumption reduction effect to be obtained by being in this state. When the vehicle 1 runs on a scheduled running route, if a lighting color of each traffic light is always green at a timing at which the vehicle 1 passes through a corresponding traffic light, the vehicle 1 can continue to run without stopping at the traffic light. Because fuel consumption deteriorates if the vehicle 1 repeats stop and drive start, by suppressing stop at a traffic light, fuel consumption improves. Thus, in the state in which green wave driving assist control is executed, an energy consumption reduction effect is obtained.

In this manner, the control apparatus 11 executes display control of calculating an energy consumption reduction effect while the vehicle 1 is running in a state in which green wave driving assist control is executed, generating an effect image B corresponding to the calculation result, and displaying the effect image B on a display apparatus 12. Also in the third embodiment, a time image A and the effect image B can be adjacently displayed by the display method illustrated in FIGS. 3 to 6.

As described above, according to the third embodiment, it becomes possible to attain a driving schedule while receiving an energy consumption reduction effect to be obtained by being in a state in which green wave driving assist control is executed.

In the present disclosure, a time image indicating time information with respect to a supposed scheduled time, and an effect image indicating an energy consumption reduction effect are displayed in real time on the display apparatus. A driver who views the image display can thereby determine how driving is to be performed to keep a balance between time and fuel consumption. Thus, both of the attainment of a driving schedule and the improvement in energy consumption reduction effect can be achieved.

According to an embodiment, a time image indicating time information with respect to a supposed scheduled time, and an effect image indicating an energy consumption reduction effect are displayed in real time on the display apparatus. A driver who views the image display can thereby determine how driving is to be performed to keep a balance between time and fuel consumption. Thus, both of the attainment of a driving schedule and the improvement in energy consumption reduction effect can be achieved.

According to an embodiment, it is possible to prevent a delay from a running schedule while receiving an energy consumption reduction effect to be obtained by platooning.

According to an embodiment, it is possible to prevent a delay from a running schedule while receiving an energy consumption reduction effect to be obtained by vehicle speed limitation.

According to an embodiment, it is possible to prevent a delay from a running schedule while receiving an energy consumption reduction effect to be obtained by so-called green wave.

According to an embodiment, it is possible to visualize goal achievability in platooning based on a targeted arrival time set from a driver's viewpoint.

According to an embodiment, it is possible to display, in real time, a time image indicating time information with respect to a supposed scheduled time, and an effect image indicating an energy consumption reduction effect. A driver who views the image display can thereby determine how driving is to be performed to keep a balance between time and fuel consumption. Thus, both of the attainment of a driving schedule and the improvement in energy consumption reduction effect can be achieved.

According to an embodiment, it is possible to prevent a delay from a running schedule while receiving an energy consumption reduction effect to be obtained by platooning.

According to an embodiment, it is possible to prevent a delay from a running schedule while receiving an energy consumption reduction effect to be obtained by vehicle speed limitation.

According to an embodiment, it is possible to prevent a delay from a running schedule while receiving an energy consumption reduction effect to be obtained by so-called green wave.

According to an embodiment, it is possible to visualize goal achievability in platooning based on a targeted arrival time set from a driver's viewpoint.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control apparatus comprising:
a control unit configured to execute display control of displaying information regarding a running vehicle on a display apparatus,
wherein, while the vehicle is running toward a destination set in navigation information, the control unit generates a time image indicating whether an estimated arrival time estimated based on a vehicle speed of the vehicle and the navigation information is shortened or prolonged with respect to an original scheduled arrival time defined by the navigation information at a running start time point, as information regarding a scheduled time at which the vehicle arrives at the destination,
wherein the control unit generates an effect image indicating an energy consumption reduction effect to be obtained in the vehicle by a current running state of the vehicle, and
wherein the control unit displays the generated time image and the effect image in real time on the display apparatus.

2. The control apparatus according to claim 1, comprising:
an effect calculation unit configured to calculate, when the vehicle is executing platooning, an energy consumption reduction effect to be obtained in the vehicle by platooning; and
a time calculation unit configured to calculate a difference between the original scheduled arrival time and the estimated arrival time,
wherein the control unit generates the effect image that is based on the energy consumption reduction effect to be obtained by the platooning that has been calculated by the effect calculation unit, and generates the time image that is based on the difference calculated by the time calculation unit.

3. The control apparatus according to claim 1, comprising:
an effect calculation unit configured to calculate, when the vehicle is running in a vehicle speed limited state, an energy consumption reduction effect to be obtained in the vehicle by vehicle speed limitation; and
a time calculation unit configured to calculate a difference between the original scheduled arrival time and the estimated arrival time,
wherein the control unit generates the effect image that is based on the energy consumption reduction effect to be obtained by the vehicle speed limitation that has been calculated by the effect calculation unit, and generates the time image that is based on the difference calculated by the time calculation unit.

4. The control apparatus according to claim 1, comprising:
an effect calculation unit configured to calculate, when the vehicle is running in a control state in which the vehicle can always pass through a traffic light in a state in which a lighting color of the traffic light is green, an energy consumption reduction effect to be obtained in the vehicle by being in the control state; and
a time calculation unit configured to calculate a difference between the original scheduled arrival time and the estimated arrival time,
wherein the control unit generates the effect image that is based on the energy consumption reduction effect to be obtained by being in the running state that has been calculated by the effect calculation unit, and generates the time image that is based on the difference calculated by the time calculation unit.

5. The control apparatus according to claim 1,
wherein the control unit sets a time designated by an occupant of the vehicle as a targeted arrival time,
wherein the control unit generates an achievability image indicating a goal achievability result obtained by comparing the targeted arrival time and the estimated arrival time that considers a delay in an arrival time at a destination that is to be caused by platooning when the vehicle is executing platooning, and
wherein the control unit displays the generated achievability image in real time on the display apparatus.

6. A display apparatus displaying information regarding a running vehicle,
wherein, while the vehicle is running toward a destination set in navigation information, the display apparatus displays, in real time, a time image indicating information regarding a scheduled arrival time at the destination and an effect image indicating an energy consumption reduction effect,
wherein the time image is an image indicating whether an estimated arrival time estimated based on a vehicle speed of the vehicle and the navigation information is shortened or prolonged with respect to an original scheduled arrival time defined by the navigation information at a running start time point, and
wherein the effect image is an image indicating an energy consumption reduction effect to be obtained in the vehicle by a current running state of the vehicle.

7. The display apparatus according to claim 6, wherein, when the vehicle is executing platooning, the display apparatus displays, in real time, the effect image corresponding to an energy consumption reduction effect to be obtained in the vehicle by platooning, and the time image corresponding to a difference between the original scheduled arrival time and the estimated arrival time.

8. The display apparatus according to claim 6, wherein, when the vehicle is running in a vehicle speed limited state, the display apparatus displays, in real time, the effect image corresponding to an energy consumption reduction effect to be obtained in the vehicle by vehicle speed limitation, and the time image corresponding to a difference between the original scheduled arrival time and the estimated arrival time.

9. The display apparatus according to claim 6, wherein, when the vehicle is running in a control state in which the vehicle can always pass through a traffic light in a state in which a lighting color of the traffic light is green, the display apparatus displays, in real time, the effect image corresponding to an energy consumption reduction effect to be obtained in the vehicle by being in the control state, and the time image corresponding to a difference between the original scheduled arrival time and the estimated arrival time.

10. The display apparatus according to claim 6,
wherein, when the vehicle is executing platooning, the display apparatus displays an achievability image indicating a goal achievability result obtained by comparing a preset targeted arrival time and the estimated arrival time that considers a delay in an arrival time at a destination that is to be caused by platooning, and
wherein the targeted arrival time is set to a time designated by an occupant of the vehicle.
